(19) United States
(12) Patent Application Publication
(10) Pub. No.: US 2019/0288533 A1
(43) Pub. Date: Sep. 19, 2019

(54) EXTERNAL BATTERY MODULE

(71) Applicant: AIRSELFIE HOLDINGS LIMITED, London (GB)

(72) Inventor: Marco STROPPIANA, London (GB)

(73) Assignee: AIRSELFIE HOLDINGS LIMITED, London (GB)

(21) Appl. No.: 16/349,176

(22) PCT Filed: Nov. 11, 2016
(86) PCT No.: PCT/IB2016/056802

§ 371 Date: May 10, 2019

(51) Int. Cl. H02J 7/00; B64C 39/02

(52) U.S. Cl. CPC H02J 7/0044; B64C 39/024; H02J 7/0054; B64C 2201/108; B64C 2201/201; B64C 2201/042; B64C 2201/066

(57) ABSTRACT

A portable external battery module includes an aerial device provided with camera, which is removably housed within a cavity made in the casing of the module. Electrical contacts are positioned in the cavity and connected to the batteries of the module and pre-arranged for connecting to electrical contacts positioned on the outside of said aerial device, when said aerial device is housed within the cavity, for recharging the internal battery of the aerial device.

The present invention relates to a portable external battery module, of the type comprising:
one or more batteries;
one or more control circuits for controlling the operation of recharging of said one or more batteries and for controlling the supply voltage of said one or more batteries; and
a casing containing said batteries and said control circuits.

The above type of device is today also referred to as “power bank” and constitutes in practice a portable battery-charger for recharging electronic devices of various kinds, such as smartphones, laptops, tablets, etc. Given the ever-increasing levels of power consumption of these electronic devices, which by now accompany everyday activities of a very large number of users, external battery modules are today very widespread.

A problem linked to these external modules is represented by the fact that they constitute to all effects and purposes an additional and separate accessory that the user must remember to carry along with him, together with the electronic device that may require recharging.

Now, in the above context, the present invention proposes a new external battery module that is pre-arranged for housing inside it an electromechanical operating device that can be recharged through the battery module itself.

In particular, the present invention regards an external battery module of the type comprising:
one or more batteries;
one or more control circuits for controlling the operation of recharging of said one or more batteries and for controlling the supply voltage of said one or more batteries; and
a casing containing said batteries and said control circuits,

said module being characterised in that it comprises an aerial device provided with camera, which is removably housed within a cavity made in said outer casing, and in that positioned in said cavity are electrical contacts that are connected to said one or more batteries and are pre-arranged for connecting to electrical contacts positioned on the outside of said aerial device, when said aerial device is housed within said cavity, for recharging the internal battery of said aerial device.

The aerial device mentioned hence presents as a part that can be perfectly integrated in the battery module. In particular, it can be conveniently transported inside its casing and be separated therefrom only at the moment when it is used. It should moreover be noted that, given that the battery module is pre-arranged for recharging the aerial device whenever this is put back therein, the device will be recharged at the moment when it is used again.

The characteristics indicated in the claims form an integral part of the technical teaching provided herein.

Further characteristics and advantages of the present invention will emerge clearly from the ensuing description with reference to the annexed drawings, which are provided purely by way of non-limiting example and in which:

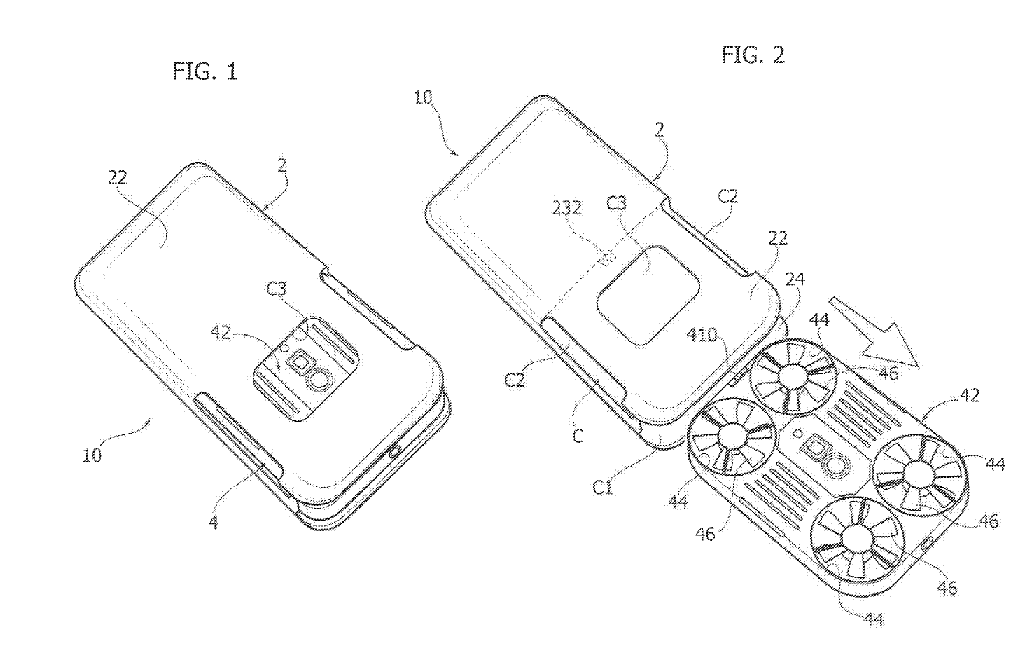

FIGS. 1 and 2 are perspective views of an embodiment of the battery module described herein, in two respective different conditions;

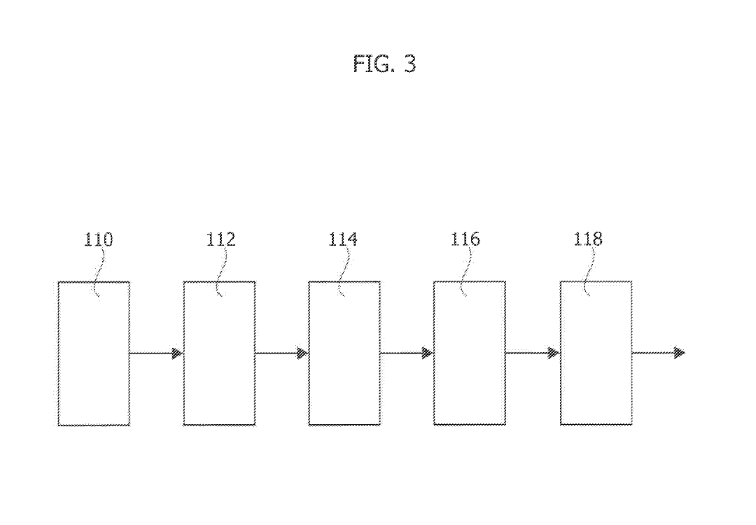

FIG. 3 is a schematic illustration of the configuration of the components for control of the battery module described herein; and

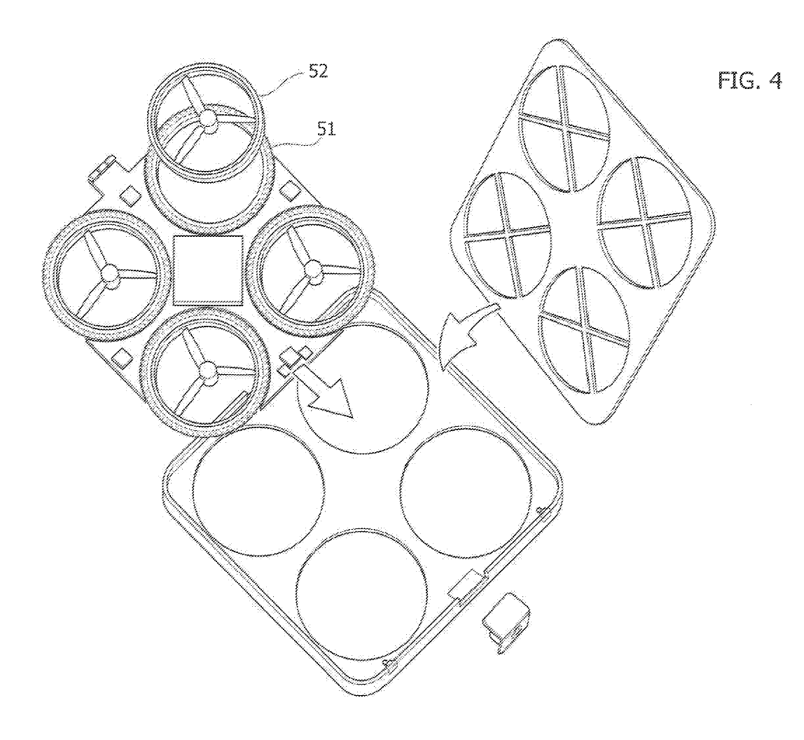

FIGS. 4, 5, 6, and 7 illustrate different embodiments of the aerial device provided in the battery module described herein.

In the ensuing description, various specific details are illustrated aimed at enabling an in-depth understanding of the embodiments. The embodiments may be provided without one or more of the specific details, or with other methods, components, or materials, etc. In other cases, known structures, materials, or operations are not shown or described in detail so that various aspects of the embodiment will not be obscured.

The references used herein are only provided for convenience and hence do not define the sphere of protection or the scope of the embodiments.

As anticipated above, the solution described herein is an external battery module characterised in that it comprises an aerial device provided with camera, which is housed within the casing of the battery module and, when it is in this condition, is recharged via the batteries of the module itself.

With reference to FIGS. 1 and 2, the module is designated as a whole by the reference number 10.

The aerial device in question, designated by the reference number 4, is a small drone that can be driven remotely and is able to fly via propelling means of its own.

Preferably, the above device is configured for being driven by a mobile electronic device such as a smartphone or else a tablet and operating through this as aerial camera for taking panoramic shots from above or else for taking self-portrait photographs, the so-called selfies.

The camera of the device may be constituted by any image-capturing device that can be operated as photographic camera and possibly also as video camera. In various preferred embodiments, the camera is carried by the device so as to be orientable about an axis, either manually or via an electromechanical adjustment system. The camera may in any case also be fixed.

Preferably, the aerial device has a wireless communication interface, preferably of a short-to-medium range type (e.g., of up to 200 m), for example a communication interface in accordance with the Wi-Fi standard (IEEE 802.11) or else with the Bluetooth standard, or equivalent technologies.

The aerial device further comprises a control unit for driving the motors of the device, for control of the camera, and for management of the data regarding the images acquired by the camera. The communication interface is configured for receiving commands from the aforementioned mobile device and for sending the images acquired by the camera of the aerial device to the mobile device. Preferably, the above transmission of images takes place in real time, and the mobile device is configured for displaying on its own screen the images transmitted in such a way that the user can see in real time the images captured by the aerial device.

The mobile device can then be configured for controlling the camera of the aerial device and for saving to memory the images taken by the camera.

In various preferred embodiments, as in the one illustrated, the aerial device has an as a whole planar body 42, having a profile in top plan view that is preferably rectangular or square, on which a plurality of through openings 44 are made that each house a corresponding rotor 46 provided with blades, which is designed to operate as propeller of the device. The various rotors of the device are driven by respective battery-supplied electric motors.

The mechanical transmission that connects the rotors 46 to the respective electric motors may envisage a wide range of configurations.

With reference to FIG. 4, these motors may, for example, present an annular configuration in which electrical windings of the motor are carried by a first ring 51 fixed to the structure of the device, whereas the rotor has a second ring 52, which surrounds the blades of the rotor and carried on which are, instead, the magnetic elements designed to co-operate with the aforesaid electrical windings. The second ring of the rotor is mounted according to a rotatable coupling inside the first ring fixed to the structure of the device.

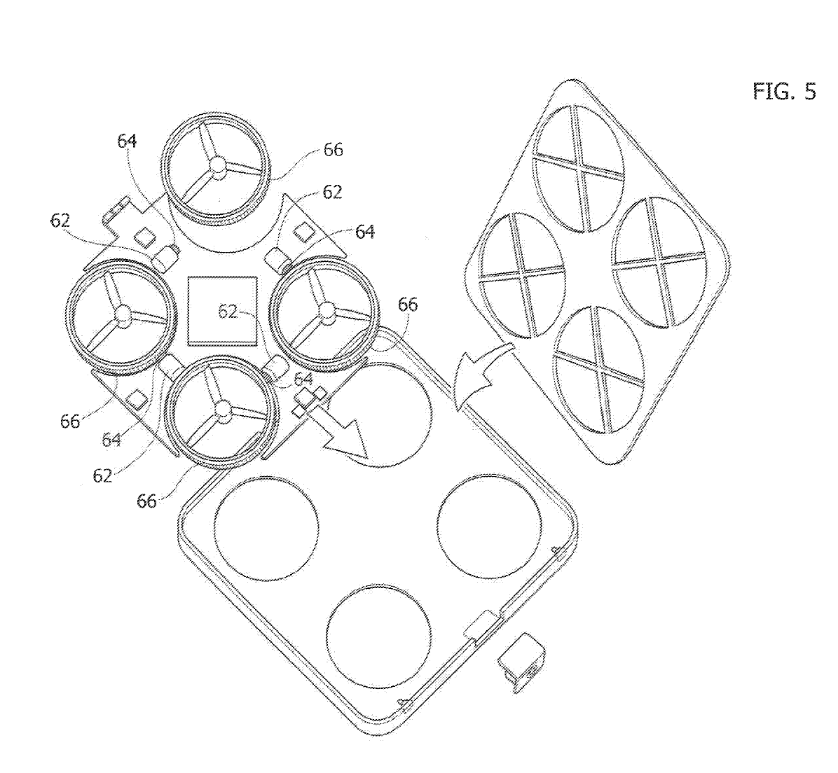

With reference to FIG. 5, in the solution illustrated therein, the electric motors are, instead, rotary electric motors of a conventional type—designated by reference number 62—fixed on the shaft of which is a pinion 64 designed to engage an external toothing made on a ring 66 of the rotor similar to the second ring indicated above of the previous alternative solution.

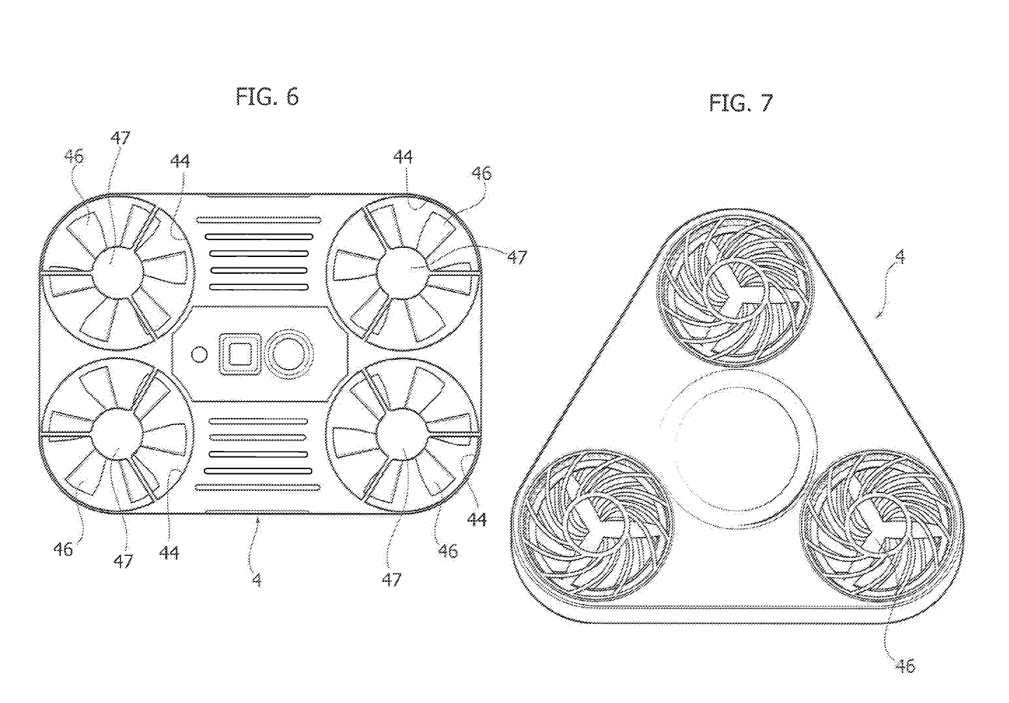

Once again with reference to FIG. 6, the electric motors are, instead, directly coupled to the hub of the rotor and are each carried by a supporting plate 47, which is set at the centre at the respective opening 44.

FIG. 7 illustrates an aerial device similar to the ones described above that differs from these only in that it has three rotors, instead of four, arranged at the vertices of a body of a triangular shape.

As may be seen from the figures described above, the aerial device according to this embodiment is characterized in that it has very small transverse dimensions in such a way that it can be housed within an internal cavity C of the battery module, as will be illustrated in what follows.

To return now to the battery module as a whole, it has an outer casing 2 having the generic shape of a flattened parallelepiped, i.e., characterised by a thickness substantially smaller than the other two dimensions (for example, one third of the second smaller dimension). The casing 2 encloses inside it the set of batteries and the control circuits of the module, which will be described hereinafter.

The casing 2 is pre-arranged for defining inside it the cavity C mentioned above, for housing the aerial device 4. In various preferred embodiments, as in the one illustrated, the above cavity is provided between the two major sides 22 and 24 of the casing and extends substantially for the entire width of the above sides, and in the longitudinal direction thereof, for a length sufficient for housing the device 4 completely. The cavity C is accessible from outside at a first slit C1, through which the aerial device 4 can be inserted within the cavity and which is made on a bottom side of the casing 2 orthogonal to the longitudinal direction thereof.

In various preferred embodiments, as in the one illustrated, the cavity C is moreover accessible from outside through two lateral slits C2 that are provided on the major side 24, in two opposite lateral regions thereof, and/or, at least partially, on the two opposite bottom sides of the casing parallel to its longitudinal direction. These slits C2 leave exposed outwards the corresponding underlying edges of the aerial device 4, which can hence be gripped by the user for taking out the device, thus facilitating removal of the device from the cavity C. Possibly, moreover provided on the major side 24 or else on the major side 22 is an opening C3 pre-arranged for rendering visible from outside a corresponding central part of the aerial device 4, for purely aesthetic purposes.

According to an important characteristic of the present invention, giving out into the cavity C are electrical contacts 232, illustrated with a dashed line, which are connected to the batteries of the module and are pre-arranged for connecting to electrical external contacts 410 of the aerial device 4 when this is housed inside the cavity C.

The device 4 is hence recharged by the module automatically, whenever it is put back therein after use, and amongst other things no wire is necessary for recharging.

In the light of what has been said above, the advantages of the battery module described herein are now evident. It makes in fact available for the user an accessory for smartphones or tablets that is altogether innovative, can be easily transported safely via the aforesaid module, and moreover is always in charged conditions and ready for use.

Again, in various preferred embodiments, the aerial device comprises a memory saved within which are the images taken by the camera of the aerial device, and these images can be transferred to a further support subsequently, for example via an output port provided on the aerial device or else through the communication interface referred to above.

In various embodiments, the battery module itself comprises a memory into which the images saved to the memory of the aerial device can be transferred. In various embodiments, it may be envisaged that the aforesaid images will be transferred via the aforesaid electrical contacts, when the aerial device is put back into the casing 2. In various alternative embodiments, the memory of the aerial device may be of an extractable type, for example in SD (Secure Digital) format, and in this case the casing 2 may envisage an input port for insertion of the aforesaid memory.

With reference now to the other components of the module described herein, this may envisage any specific configuration of conventional portable external battery modules.

Purely by way of example, FIG. 3 illustrates via a block diagram a possible configuration of the battery module described herein.

In various preferred embodiments, as in the one illustrated, the above module comprises a battery unit 110, a recharging circuit 112 connected to the battery unit, an input port 114 connected to the recharging circuit, a supply circuit 116 connected to the battery unit, and an output port 118 connected to the supply circuit.

The input port 114 has the function of connecting the battery module with an external power mains supply, for being able to recharge the battery unit 110, and the recharging circuit 112 has the function of regulating the voltage and/or the current with which the battery unit 110 is recharged.

On the other hand, the output port 118 carries, instead, the electrical contacts referred to above, contained in the cavity C, for recharging the aerial device. The supply circuit 116 has, instead, the function of regulating in a pre-determined way, for example at a pre-set value, the supply voltage that is made available on the aforesaid electrical contacts.

In various preferred embodiments, as in the one illustrated, the battery module further comprises a control circuit designed to monitor one or more of the following control parameters of the module: the temperature of the battery unit, the voltage of the battery unit, the voltage and the current at the output port, etc.

Possibly, the module in question may also comprise a microcontroller for implementation of functions of fast recharging of the battery unit.

Again, in various preferred embodiments, as in the one illustrated, the battery module may comprise various indicators, for example LED sources, for communicating to the user information on the operating state of the module, such as the battery level, the active state of the function of recharging of the aerial device, the active state of the function of recharging of the battery unit, etc.

Preferably, the battery module also comprises an output port for recharging mobile devices, such as smartphones and tablets. The battery module itself may then being used for recharging the device for control of the aerial device. The output port may, for example, be a USB (Universal Serial Bus) port.

Of course, without prejudice to the principle of the invention, the details of construction and the embodiments may vary, even significantly, with respect to what is illustrated herein purely by way of non-limiting example, without thereby departing from the scope of the invention, as this is defined in the annexed claims.

1. An external battery module comprising:
one or more batteries;
one or more control circuits for controlling the operation of recharging of said one or more batteries and for controlling the supply voltage of said one or more batteries;
a casing containing said batteries and said control circuits;
an aerial device provided with camera, which is removably housed within a cavity made in said casing,
electrical contacts positioned in said cavity and connected to said one or more batteries and designed to be set in connection with electrical contacts positioned on the outside of said aerial device, when said aerial device is housed within said cavity, for recharging said aerial device.

2. The module according to claim 1, wherein said aerial device comprises a generically planar body, provided with through opening housed in which are rotors for propulsion of said aerial device.

3. The module according to claim 2, wherein said rotors of said aerial device are driven by respective electric motors.

4. The module according to claim 3, wherein said electric motors are of an annular type and comprise a first ring, which carries a series of windings of electrical wires and which is fixed to said planar body at said respective opening, and a second ring forming part of said rotor, which carries, on the outside, a series of magnetic elements designed to co-operate with said series of windings of electrical wires, and which carries, on the inside, the blades of said rotor.

5. The module according to claim 3, wherein said rotors have a perimetral ring provided on the outer edge of which is a toothing that is engaged by a gear wheel driven by said motor.

6. The module according to claim 3, wherein said electric motors are each coupled to the hub of the respective rotor and are carried by a supporting plate that is positioned centrally at the opening housed in which is said rotor.

7. The module according to claim 1, wherein said cavity is accessible from outside through a first slit of said casing, through which said aerial device can be inserted within said cavity, and wherein said cavity is accessible from two further slits of said casing, which are configured for leaving two opposed underlying edges of said aerial device exposed outwards, in such a way that these can be gripped by the user for taking said aerial device out of said cavity.

8. The module according to claim 1, wherein said aerial device has a wireless communication interface for controlling said aerial device and sending images from said camera to an external mobile device, such as a smartphone or else a tablet.

9. The module according to claim 1, wherein said aerial device comprises a battery.
